(19) United States
(12) Patent Application Publication
(10) Pub. No.: US 2026/0228568 A1
(43) Pub. Date: Aug. 6, 2026

(54) Technologies for Determining Discernment in Generative Artificial Intelligence

(71) Applicant: The PNC Financial Services Group, Inc., Pittsburgh, PA (US)

(72) Inventors: Trevor Daniel Sullivan, Madison, WI (US); Sage Jordan Betko, Pittsburgh, PA (US)

(21) Appl. No.: 19/463,605

(22) Filed: Jan. 29, 2026

Related U.S. Application Data
(60) Provisional application No. 63/752,207, filed on Jan. 31, 2025.

(51) Int. Cl. G06N 5/022; G06F 18/21

(52) U.S. Cl. CPC G06N 5/022; G06F 18/217

(57) ABSTRACT

Technologies for determining discernment in generative artificial intelligence include a compute device. The compute device includes circuitry configured to obtain a testing dataset comprising a plurality of questions and responses between one or more users and one or more large language models. In some cases, the responses from the one or more large language models are based, at least in part, on information in a knowledge base. The circuitry may be further configured to determine a discernment score for the testing dataset in which the discernment score represents a measurement of whether there was enough information in the knowledge base for the one or more large language models to answer the questions in the testing dataset. Other embodiments are also described.

### CROSS-REFERENCE TO RELATED APPLICATION

The present application claims priority under 35 U.S.C. § 119(e) to U.S. Provisional Application Ser. No. 63/752,207, filed Jan. 31, 2025, the entire disclosure of which is hereby incorporated by reference.

### BACKGROUND

Generative artificial intelligence (“AI”) is a type of AI that uses machine learning, such as large language models (LLMs), to create new content. LLMs can be trained on large datasets to perform a variety of tasks, and can be a valuable tool, but challenges remain. For example, although LLMs can be trained to answer users' questions, these systems can inadvertently generate “hallucinations,” which are incorrect, misleading and/or nonsensical information. There are environments, such as institutional banks, in which risk of LLM hallucinations cannot be tolerated because an imperfect answer could lead to outsize consequences.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements. The detailed description particularly refers to the accompanying figures in which:

FIG. 1 is a simplified block diagram of at least one embodiment of a system for determining discernment in a generative artificial intelligence system;

FIG. 2 is a simplified block diagram of at least one embodiment of a compute device of the system of FIG. 1;

FIGS. 3-4 are simplified block diagrams of at least one embodiment of a method for generating an adjusted response rate based on a discernment score that may be performed by the system of FIG. 1; and

FIGS. 5-6 are simplified block diagrams of at least one embodiment of a method for making real-time adjustments to a generative artificial intelligence system based on a discernment score that may be performed by the system of FIG. 1.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

Large language models are a type of artificial intelligence models that can generate a human-like responses to questions. One performance metric for large language models is response rate, which is the ratio of questions that the large language models answers (instead of declining to answer) to the total number of questions. Typically, a higher response rate is considered a better metric than a lower response rate. However, there is a technical problem using the raw response rate as a performance metric. Because there will always be information that users want that is not present in source documents, there will be times that the system should decline to answer, especially since false positives are more harmful than false negatives.

Embodiments of this disclosure attempt to measure these situations in a discernment score, which represents the system's ability to correctly decline to answer questions. The discernment metric evaluates the large language model's capacity to withhold a response when it lacks sufficient information, specifically when no relevant or accurate information is present in the retrieved documents. In such cases, the model should ideally issue a clear signal expressing that it cannot confidently answer the question due to lack of reliable context. For example, the discernment score could be determined as:

$$D = \frac{1}{\vert {Q}_{unanswered} \vert} {\sum }_{q ∈ {Q}_{unanswered}} 1 - A ( q , c ) ,$$

$$\{ \begin{matrix}{Q}_{unanswered} = set of unanswered questions \\ A ( q , c ) = answerability score of q and c\end{matrix}$$

Where A(q, c) is a function that maps the question and the contextual information to a score between 0 and 1. A score of 0 indicates that no aspect of the question can be answered from the context, and 1 indicates that the query can be answered completely and correctly from the context. Intermediate values indicate partial answerability in circumstances where some—but not all—aspects of the question may be answered correctly from the context. While this example describes a discernment score between 0 and 1, this is for illustrative purposes only. The discernment score could be any numerical range; also, the range between completely unanswerable to fully answerable could be flipped so a lower score means the question could be fully answered and a higher score means the question cannot be answered at all, or vice versa.

With the discernment score measured, a discernment-adjusted response rate can be determined, which does not penalize the large language model for questions that it was not able to answer. For example, the discernment-adjusted response rate for a set of questions Q could be determined as:

$$Discernment Adjusted Response Rate = \frac{\vert {Q}_{a n s w e r e d} \vert}{\vert Q \vert - {\sum }_{q ∈ {Q}_{u n a n swered}} ( 1 - A ( q , c ) )}$$

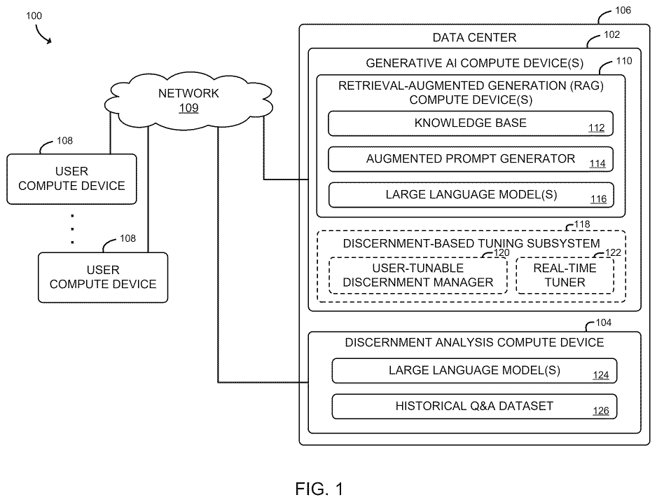

Referring now to FIG. 1, a system 100 for determining discernment in generative artificial intelligence (“AI”) includes, in the illustrative embodiment, generative AI compute devices 102 and a discernment analysis compute device 104. The compute devices 102, 104 may be located in a data center 106 (e.g., a facility housing compute devices, thermal control equipment, power management equipment, and networking equipment to support the operations of the compute devices). In the illustrative embodiment, the generative AI compute devices 102 are communicatively connected to a set of user compute devices 108 via a network 109.

In some embodiments, the compute devices 102, 104 may associated with a financial institution, such as a bank. The user compute devices 108 could be used by employees and/or customers of the financial institution to, among other things, submit queries or questions to the generative AI compute devices 102. By way of example, the users who are employees could submit questions through internal software components of the financial institution. In some cases, users that are customers of the financial institution could submit questions through customer service channels, such as chatbots, AI agents, automated customer service workflows, call management, etc. The generative AI compute devices 102 include one or more large language models to generate responses to questions. The discernment analysis compute device 104 may be used for performance management of the generative AI compute devices 102 to analyze questions from the user compute devices 108 and responses from the generative AI compute devices 102 to determine a discernment score on a historical dataset. While the system 100 and methods performed by the system 100 are described herein with reference to the financial institution, the system 100 and methods could be used in the context of other organizations as well.

In the illustrative embodiment, the generative AI compute devices 102 are embodied as retrieval-augmented generation (“RAG”) compute devices 110 with a knowledge base 112, an augmented prompt generator 114, one or more large language models 116, and an optional discernment-based tuning subsystem 118. The augmented prompt generator 114 may be configured to combine contextual information from the knowledge base 112 with the question received from the user compute device 108 to generate an augmented prompt that is fed to the one or more large language models 116, which generates a response that is provided to the user compute device 108. Consider an example in which user compute device 108 is used by the financial institution's employees and the knowledge base 112 is loaded with proprietary information, such as a corpus of the financial institution's procedures, policies, and processes. This would allow the augmented prompt generator 114 to generate an augmented prompt that includes relevant information about the financial institution's internal policies and procedures that is stored in the knowledge base. Consider another example in which the user compute device 108 is used by the financial institution's customers and the knowledge base is loaded with transcripts of customer service sessions. The augmented prompt generator 114 could retrieve relevant information from customer service sessions in the knowledge base 112 to generate an augmented prompt for the large language models 116 that combines the relevant information from the knowledge base 112 and the user's question. The large language models 116 could then provide a response to the user compute device 108 based on the augmented prompt.

In the example shown, the RAG compute devices 110 optionally include the discernment-based tuning subsystem 118 that is configured to provide real-time adjustments to the generative AI compute devices 102 based on a discernment score. The discernment-based tuning subsystem 118 could be enabled or disabled depending on the circumstances, such as available latency or other performance metrics. In the illustrative embodiment, the discernment-based tuning subsystem 118 includes a user-tunable discernment manager 120 and a real-time tuner 122. As discussed herein, the discernment-based tuning subsystem 118 could be used to set a minimum discernment score, which could be user-adjustable, for the large language models 116 to answer a question. If the minimum discernment score is not satisfied, the RAG compute device 110 could decline to answer the question in real-time. In some cases, the discernment-based tuning subsystem 118 could tune the augmented prompt in real-time to improve system-wide discernment score by eliciting an answer in cases where an answer is possible.

In the illustrative embodiment, the discernment analysis compute device 104 is a performance testing system to determine discernment scores for historical data in sessions between user compute devices 108 and the large language models 116. The discernment scores determined by the discernment analysis compute device 104 could be used to tune the performance of the large language models 116 and/or the augmented prompt generator 114. As shown, the discernment analysis compute device 104 includes one or more large language models 124 that determine the discernment score and a historical Q&A dataset 126 representing a plurality of interactions with the large language models 116.

While relatively few compute devices 102, 104, 108, 110 are shown in FIG. 1 for simplicity and clarity, it should be understood that the number of compute devices, in practice, may range in the tens, hundreds, thousands, or more. Likewise, it should be understood that the compute devices 102, 104, 108, 110 may be distributed differently or perform different roles than the configuration shown in FIG. 1. Further, though shown as separate compute devices 102, 104, 108, 110 in some embodiments, the functionality of one or more of the compute devices 102, 104, 108, 110 may be combined into fewer compute devices and/or distributed across more compute devices than those shown in FIG. 1.

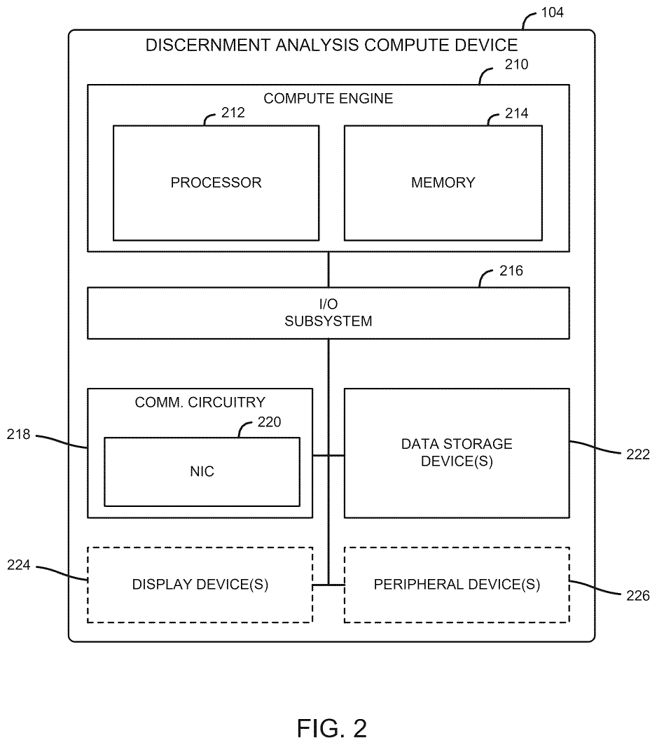

Referring now to FIG. 2, the illustrative discernment analysis compute device 104 includes a compute engine 210, an input/output (I/O) subsystem 216, communication circuitry 218, and one or more data storage devices 222. In some embodiments, the discernment analysis compute device 104 may include one or more display devices 224 and/or one or more peripheral devices 226 (e.g., a mouse, a physical keyboard, etc.). In some embodiments, one or more of the illustrative components may be incorporated in, or otherwise form a portion of, another component. The compute engine 210 may be embodied as any type of device or collection of devices capable of performing various compute functions described below. In some embodiments, the compute engine 210 may be embodied as a single device such as an integrated circuit, an embedded system, a field-programmable gate array (FPGA), a system-on-a-chip (SOC), or other integrated system or device. Additionally, in the illustrative embodiment, the compute engine 210 includes or is embodied as a processor 212 and a memory 214. The processor 212 may be embodied as any type of processor capable of performing the functions described herein. For example, the processor 212 may be embodied as a single or multi-core processor(s), a microcontroller, or other processor or processing/controlling circuit. In some embodiments, the processor 212 may be embodied as, include, or be coupled to an FPGA, an application specific integrated circuit (ASIC), reconfigurable hardware or hardware circuitry, or other specialized hardware to facilitate performance of the functions described herein.

In embodiments, the processor 212 is capable of receiving, e.g., from the memory 214 or via the I/O subsystem 216, a set of instructions which when executed by the processor 212 cause the discernment analysis compute device 104 to perform one or more operations described herein. In embodiments, the processor 212 is further capable of receiving, e.g., from the memory 214 or via the I/O subsystem 216, one or more signals from external sources, e.g., from the peripheral devices 226 or via the communication circuitry 218 from an external compute device, external source, or external network. As one will appreciate, a signal may contain encoded instructions and/or information. In embodiments, once received, such a signal may first be stored, e.g., in the memory 214 or in the data storage device(s) 222, thereby allowing for a time delay in the receipt by the processor 212 before the processor 212 operates on a received signal. Likewise, the processor 212 may generate one or more output signals, which may be transmitted to an external device, e.g., an external memory or an external compute engine via the communication circuitry 218 or, e.g., to one or more display devices 224. In some embodiments, a signal may be subjected to a time shift in order to delay the signal. For example, a signal may be stored on one or more storage devices 222 to allow for a time shift prior to transmitting the signal to an external device. One will appreciate that the form of a particular signal will be determined by the particular encoding a signal is subject to at any point in its transmission (e.g., a signal stored will have a different encoding that a signal in transit, or, e.g., an analog signal will differ in form from a digital version of the signal prior to an analog-to-digital (A/D) conversion).

The main memory 214 may be embodied as any type of volatile (e.g., dynamic random access memory (DRAM), etc.) or non-volatile memory or data storage capable of performing the functions described herein. Volatile memory may be a storage medium that requires power to maintain the state of data stored by the medium. In some embodiments, all or a portion of the main memory 214 may be integrated into the processor 212. In operation, the main memory 214 may store various software and data used during operation such as machine learning models, historical Q&A datasets, applications, libraries, and drivers.

The compute engine 210 is communicatively coupled to other components of the discernment analysis compute device 104 via the I/O subsystem 216, which may be embodied as circuitry and/or components to facilitate input/output operations with the compute engine 210 (e.g., with the processor 212 and the main memory 214) and other components of the discernment analysis compute device 104. For example, the I/O subsystem 216 may be embodied as, or otherwise include, memory controller hubs, input/output control hubs, integrated sensor hubs, firmware devices, communication links (e.g., point-to-point links, bus links, wires, cables, light guides, printed circuit board traces, etc.), and/or other components and subsystems to facilitate the input/output operations. In some embodiments, the I/O subsystem 216 may form a portion of a system-on-a-chip (SoC) and be incorporated, along with one or more of the processor 212, the main memory 214, and other components of the discernment analysis compute device 104, into the compute engine 210.

The communication circuitry 218 may be embodied as any communication circuit, device, or collection thereof, capable of enabling communications over a network between the discernment analysis compute device 104 and another device (e.g., a compute device 102, 104, 108, 110, etc.). The communication circuitry 218 may be configured to use any one or more communication technology (e.g., wired or wireless communications) and associated protocols (e.g., Ethernet, Wi-Fi®, WiMAX, Bluetooth®, etc.) to effect such communication.

The illustrative communication circuitry 218 includes a network interface controller (NIC) 220. The NIC 220 may be embodied as one or more add-in-boards, daughter cards, network interface cards, controller chips, chipsets, or other devices that may be used by the discernment analysis compute device 104 to connect with another compute device (e.g., a compute device 102, 104, 108, 110, etc.). In some embodiments, the NIC 220 may be embodied as part of a system-on-a-chip (SoC) that includes one or more processors, or included on a multichip package that also contains one or more processors. In some embodiments, the NIC 220 may include a local processor (not shown) and/or a local memory (not shown) that are both local to the NIC 220. Additionally or alternatively, in such embodiments, the local memory of the NIC 220 may be integrated into one or more components of the discernment analysis compute device 104 at the board level, socket level, chip level, and/or other levels.

Each data storage device 222, may be embodied as any type of device configured for short-term or long-term storage of data such as, for example, memory devices and circuits, memory cards, hard disk drives, solid-state drives, or other data storage device. Each data storage device 222 may include a system partition that stores data and firmware code for the data storage device 222 and one or more operating system partitions that store data files and executables for operating systems.

Each display device 224 may be embodied as any device or circuitry (e.g., a liquid crystal display (LCD), a light emitting diode (LED) display, a cathode ray tube (CRT) display, etc.) configured to display visual information (e.g., text, graphics, etc.) to a user. In some embodiments, a display device 224 may be embodied as a touch screen (e.g., a screen incorporating resistive touchscreen sensors, capacitive touchscreen sensors, surface acoustic wave (SAW) touchscreen sensors, infrared touchscreen sensors, optical imaging touchscreen sensors, acoustic touchscreen sensors, and/or other type of touchscreen sensors) to detect selections of on-screen user interface elements or gestures from a user.

In the illustrative embodiment, the components of the discernment analysis compute device 104 are housed in a single unit. However, in other embodiments, the components may be in separate housings, in separate racks of a data center, and/or spread across multiple data centers or other facilities. The compute devices 102, 108, 110 may have components similar to those described in FIG. 2 with reference to the discernment analysis compute device 104. The description of those components of the discernment analysis compute device 104 is equally applicable to the description of components of the compute devices 102, 108, 110. Further, it should be appreciated that any of the devices 102, 108, 110 may include other components, sub-components, and devices commonly found in a computing device, which are not discussed above in reference to the discernment analysis compute device 104 and not discussed herein for clarity of the description.

In the illustrative embodiment, the compute devices 102, 104, 108, 110, are in communication via a network 109, which may be embodied as any type of wired or wireless communication network, including global networks (e.g., the internet), wide area networks (WANs), local area networks (LANs), digital subscriber line (DSL) networks, cable networks (e.g., coaxial networks, fiber networks, etc.), cellular networks (e.g., Global System for Mobile Communications (GSM), Long Term Evolution (LTE), Worldwide Interoperability for Microwave Access (WiMAX), 3G, 4G, 5G, etc.), a radio area network (RAN), or any combination thereof.

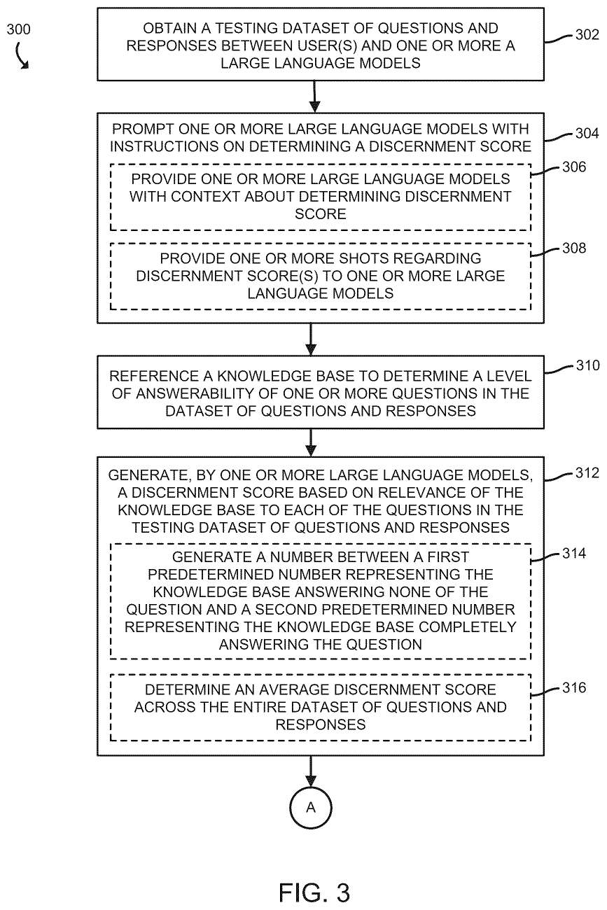

Referring now to FIG. 3, the system 100, and more specifically, the discernment analysis compute device 104, in the illustrative embodiment, may perform a method 300 for measurement of a discernment score to generate an adjusted response rate for a dataset of historical questions and answers between user compute devices 108 and the large language models 116, respectively. The method 300 begins with block 302 in which the discernment analysis compute device 104 obtains a testing dataset of questions and responses between users and one or more large language models. For example, the testing dataset could be the historical dataset 126 representing questions and answers between user compute devices 108 and the large language models 116. The method 300 advances to block 304 in which the discernment analysis compute device 104 prompts one or more large language models 124 with instructions for determining a discernment score. For example, the discernment analysis compute device 104 could provide one or more large language models 124 with context about determining the discernment score, as indicated by block, 306. In some cases, as indicated by block 308, the discernment analysis compute device 104 could provide one or more shots (e.g., examples) to the one or more large language models 124 regarding discernment scoring. As indicated by block 310, the discernment analysis compute device 104 may reference the knowledge base 112 to determine a level of answerability of one or more questions. Below is a snippet from an example prompt template that could be provided to the large language models 124 for discernment scoring based on a QUESTION (e.g., questions from user compute devices 108) and a certain SOURCE (e.g., knowledge base 112):
LLM ANSWERABILITY_SYSTEM=PromptTemplate.from_template(′″
You are an ANSWERABILITY classifier; providing the answerability of a QUESTION given a certain SOURCE.
Respond only as a number from 0 to 10 where 0 means the SOURCE has no information that might answer the QUESTION, and 10 means the SOURCE has enough information to completely answer the QUESTION
Do not consider the quality of the question, only if the SOURCE has sufficient information to answer it.

A few additional scoring guidelines:
Long QUESTIONS or SOURCES should score equally well as short ones.
SOURCE must provide enough information to answer the entire QUESTION to get a score of 10.
SOURCE that answers none of the QUESTION should get a score of 0.
SOURCE that answers some of the QUESTION should get as score of 2, 3, or 4. Higher score indicates more RELEVANCE.
SOURCE that answers most of the QUESTION should get a score between a 5, 6, 7 or 8. Higher score indicates more RELEVANCE.
SOURCE that answers the entire QUESTION should get a score of 9 or 10.
SOURCE that is relevant and contains information to answer the entire QUESTION completely should get a score of 10.
SOURCE that is only seemingly relevant should get a score of 0.
Do not consider the amount of SOURCE that is irrelevant to the QUESTION, if a very small section of the SOURCE would perfectly answer the QUESTION, it should still get a score of 10 Never elaborate.′″)

As indicated by block 312, the discernment analysis compute device 104 uses the one or more large language models 124 to generate a discernment score based on relevance of the knowledge base 112 to each of the questions in the testing dataset (e.g., historical Q&A dataset 126). For example, the discernment analysis compute device 104 could generate a number between a first predetermined number (e.g., 0) representing that none of the question can be answered based on the knowledge base 112 and a second predetermined number (e.g., 10) representing that the large language model could fully answer the question based on the knowledge base 112, as indicated by block 314. In some cases, the discernment analysis compute device 104 may determine an average discernment score across the entire dataset (e.g., dataset 126), as indicated by block 316.

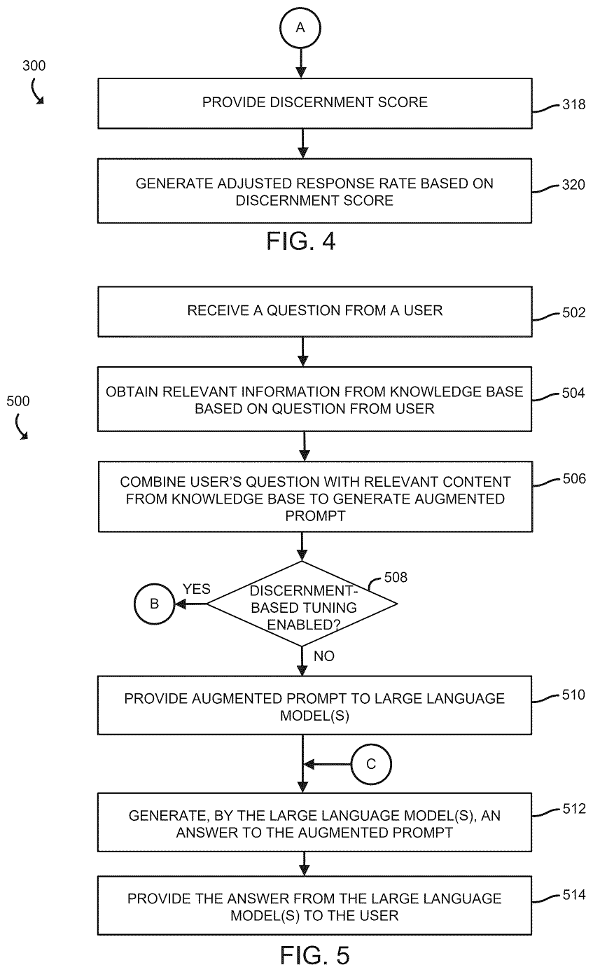

Referring now to FIG. 4, the method 300 continues to block 318 in which the discernment analysis compute device 104 provides the discernment score, which could be on a per-question basis and/or an average discernment score for the entire testing dataset. This allows the discernment analysis compute device 104 to generate an adjusted response rate based on the discernment score, as indicated by block 320. As discussed herein, the adjusted response rate is the ratio of the total answers by the large language models 118 to the total number of answerable questions. An answerable question could be any questions in which the discernment score is above a predetermined threshold. In some cases, the discernment score threshold for determining whether a question is considered answerable could be user-adjustable to allow adjustments for circumstances in which false positive answers are more or less critical.

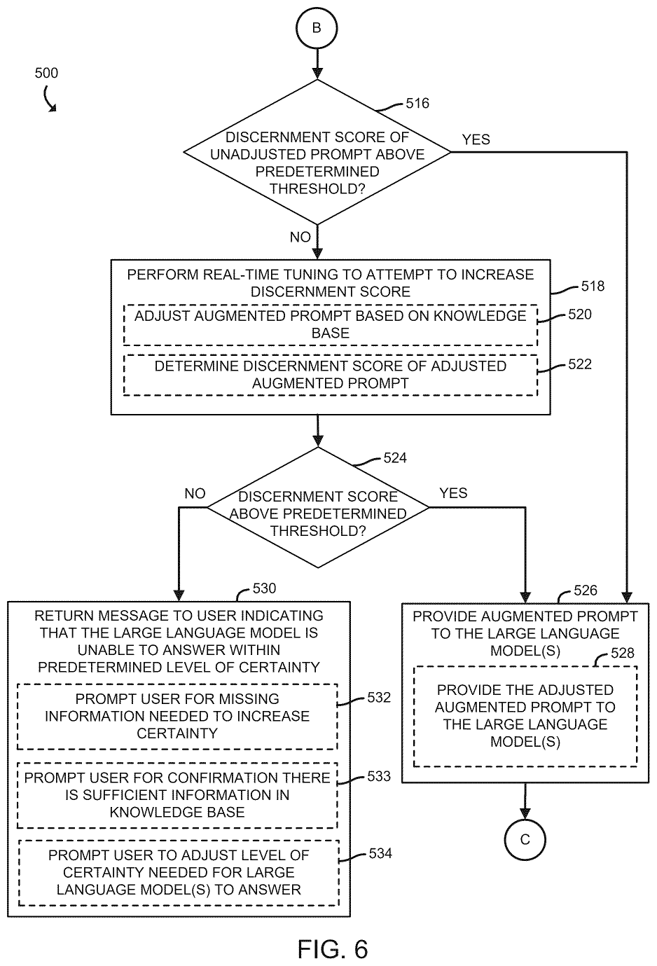

Referring now to FIGS. 5 and 6, the system 100, and more specifically, the retrieval-augmented generation (“RAG”) compute device 110, in the illustrative embodiment, may perform a method 500. As discussed herein, in the illustrative embodiment, the RAG compute device 110 may include real-time tuning based on measurement of a discernment score using the discernment-based tuning subsystem 118. The method 500 begins with block 502 of FIG. 5 in which the RAG compute device 110 receives a question from a user, such as from the user compute device 108. The RAG compute device 110 obtains the relevant information from the knowledge base 112 based on the question from the user as indicated by block 504. As discussed herein, an example of the knowledge base 112 could be proprietary information of a financial institution, such as internal policies and procedures, and the question could relate to a specific policies and/or procedure of the institution. In that example, the RAG compute device 110 could retrieve information about the specific policies and/or procedures to which the question relates. In an example in which the user is a customer of the financial institution, and the question relates to a customer service issue, the knowledge base 112 could include transcripts of customer service logs (and/or other customer service data). In that example, the RAG compute device 110 could retrieve customer support information related to the customer service question of the user. Regardless of whether the user is a customer or employee of the financial institution, as indicated by block 506, the RAG compute device 110 could combine the user's question with the relevant content from the knowledge base 112 to generate an augmented prompt using the augmented prompt generator 114.

The method 500 proceeds to block 508 in which a determination is made whether the discernment-based tuning subsystem 118 is enabled. If the discernment-based tuning subsystem 118 is not enabled, the method 500 advances to block 510 in which the augmented prompt is provided to the large language models 118. The large language models 118 then generate the answer as indicated by block 512, which is provided to the user compute device 108 as indicated by block 514.

If the discernment-based tuning subsystem 118 is enabled, referring now to FIG. 6, the method 500 advances to block 516 in which the discernment-based tuning subsystem 118 determines whether a discernment score based on the user's question with reference to the knowledge base 112 exceeds a threshold score. For example, the discernment-based tuning subsystem 118 may make a call to the large language models 124 of the discernment analysis compute device 104 and/or could include one or more large language models trained to determine discernment scores. In some cases, as explained herein, the threshold discernment score could be user-adjustable. If the discernment score falls below the predetermined threshold, the discernment-based tuning subsystem 118 may perform real time tuning to attempt to increase the discernment score above the threshold as indicated by block 518. For example, the discernment-based tuning subsystem 118 could adjust the augmented prompt by reducing or adding content from the knowledge base 112 (block 520), and then measure the discernment score of the adjusted augmented prompt (block 522). A determination is then made whether the discernment score of the adjusted augmented prompt is above the predetermined threshold, as indicated by block 524. If the initial augmented prompt (or the adjusted augmented prompt) has a discernment score above the threshold, the prompt is provided to the large language models 116 as indicated by blocks 526 and 528, respectively. The large language models 116 will then generate an answer (block 512) that is provided to the user compute device 108, as indicated by block 514.

If the discernment scores of the initial and adjusted augmented prompts are below the threshold, the method 500 proceeds to block 530 in which the RAG compute device 110 returns a message to the user compute device 108 indicating that the large language models 116 are unable to answer the question within a predetermined level of certainty. In some cases, the RAG compute device 110 could prompt the user for missing information needed to increase certainty as indicated by block 532. For example, the RAG compute device 110 and user compute device 108 could have one or more interactions in which the user provides additional context to the question, and the RAG compute device 110 could determine an adjusted discernment score based on the additional context until the user has provided sufficient context to surpass the threshold discernment score.

In some cases, the RAG compute device 110 could prompt the user to confirm whether there is sufficient information in the knowledge base 112 to answer the question, as indicated by block 533. For example, one takeaway from the discernment score is determining whether the large language model(s) are being appropriately conservative when it refuses to answer. If a discernment score is generated that fails to meet a threshold score in real time, that means that the one or more large language models have a lack of certainty in the relevance of information provided, when the model determining the discernment score has determined that certainty is warranted. Low discernment means the large language model(s) held back when it should have answered. One possible remedy that a user can provide in this case is confirming to the too-timid model that the information that it already has is sufficient. So in a situation where the model is too timid, the system could prompt the user for judgement on the knowledge base content. For example, the system could ask the user, “is this the right document for addressing your question?” If the user replies in the affirmative, the augmented prompt can be modified in a way that grants additional certainty to the answering model. If the user replies in the negative, then this exchange will become a counterexample to improve the performance of the discernment judge model itself (e.g., large language model(s) 124) because the user has disagreed with the discernment judge.

In some cases, the RAG compute device 110 could prompt the user whether it would like to adjust the level of certainty needed for the large language models 116 to answer the question as indicated by block 534. For example, if the question is one where the user would prefer an answer, even if there is a greater risk of the answer might include incorrect information, it may be preferable for the user to adjust the threshold discernment score for the question to obtain an answer than have the RAG compute device 110 decline to answer.

While certain illustrative embodiments have been described in detail in the drawings and the foregoing description, such an illustration and description is to be considered as exemplary and not restrictive in character, it being understood that only illustrative embodiments have been shown and described and that all changes and modifications that come within the spirit of the disclosure are desired to be protected. For example, while the above methods and systems are described in connection with a financial institution, it will be appreciated by those skilled in the art that the methods and systems could be equally used in the context of other institutions or organizations. There exist a plurality of advantages of the present disclosure arising from the various features of the apparatus, systems, and methods described herein. It will be noted that alternative embodiments of the apparatus, systems, and methods of the present disclosure may not include all of the features described, yet still benefit from at least some of the advantages of such features. Those of ordinary skill in the art may readily devise their own implementations of the apparatus, systems, and methods that incorporate one or more of the features of the present disclosure.

### EXAMPLES

Illustrative examples of the technologies disclosed herein are provided below. An embodiment of the technologies may include any one or more, and any combination of, the examples described below.

Example 1 includes a compute device comprising circuitry configured to obtain a testing dataset comprising a plurality of questions and responses between one or more users and one or more large language models, wherein responses from the one or more large language models are based, at least in part, on information in a knowledge base; and determine a discernment score for the testing dataset, wherein the discernment score represents a measurement of whether there was enough information in the knowledge base for the one or more large language models to answer the questions in the testing dataset.

Example 2 includes the subject matter of Example 1, and wherein to determine the discernment score comprises to determine the discernment score using one or more large language models.

Example 3 includes the subject matter of any of Examples 1 and 2, and wherein to determine the discernment score comprises to prompt the one or more large language models with instructions on how to determine the discernment score.

Example 4 includes the subject matter of any of Examples 1-3, and wherein to determine the discernment score comprises to provide the one or more large language models with rules on how to determine the discernment score.

Example 5 includes the subject matter of any of Examples 1-4, and wherein to determine the discernment score comprises to provide one or more shots regarding discernment scoring to the one or more large language models.

Example 6 includes the subject matter of any of Examples 1-5, and wherein to determine the discernment score includes determining a relevance of each question in the testing dataset to information in the knowledge base.

Example 7 includes the subject matter of any of Examples 1-6, and wherein to determine the discernment score comprises generating, for at least a portion of the questions in the test dataset, a number between a first predetermined number and a second predetermined number.

Example 8 includes the subject matter of any of Examples 1-7, and wherein the first predetermined number represents a question in which information in the knowledge base answering none of the question.

Example 9 includes the subject matter of any of Examples 1-8, and wherein the second predetermined number represents a question in which information in the knowledge base completely answers the question.

Example 10 includes the subject matter of any of Examples 1-9, and wherein the discernment score is an average of the discernment score determined for each question in the test dataset.

Example 11 includes the subject matter of any of Examples 1-10, and wherein the circuitry is further configured to generate an adjusted response rate for the testing dataset that represents a percentage of responses in the testing dataset in which the one or more learning models declined to answer a question excluding questions where the discernment score is below a threshold discernment score.

Example 12 is a method comprising obtaining, with a compute device, a testing dataset comprising a plurality of questions and responses between one or more users and one or more large language models, wherein responses from the one or more large language models are based, at least in part, on information in a knowledge base; and determining, with a compute device, a discernment score for the testing dataset, wherein the discernment score represents a measurement of whether there was enough information in the knowledge base for the one or more large language models to answer the questions in the testing dataset.

Example 13 includes the subject matter of Example 12, and wherein determining the discernment score comprises determining the discernment score using one or more large language models.

Example 14 includes the subject matter of Examples 12 and 13, and wherein determining the discernment score comprises prompting the one or more large language models with instructions on how to determine the discernment score.

Example 15 includes the subject matter of any of Examples 1-14, and wherein determining the discernment score comprises providing the one or more large language models with rules on how to determine the discernment score.

Example 16 includes the subject matter of any of Examples 1-15, and wherein determining the discernment score comprises providing one or more shots regarding discernment scoring to the one or more large language models.

Example 17 includes the subject matter of any of Examples 1-16, and wherein to determine the discernment score includes determining a relevance of each question in the testing dataset to information in the knowledge base.

Example 18 includes the subject matter of any of Examples 1-17, and wherein determining the discernment score comprises generating, for at least a portion of the questions in the test dataset, a number between a first predetermined number and a second predetermined number.

Example 19 includes the subject matter of any of Examples 1-18, and wherein the first predetermined number represents a question in which information in the knowledge base answering none of the question.

Example 20 includes the subject matter of any of Examples 1-19, and wherein the second predetermined number represents a question in which information in the knowledge base completely answers the question.

Example 21 includes the subject matter of any of Examples 1-20, and wherein the discernment score is an average of the discernment score determined for each question in the test dataset.

Example 22 includes the subject matter of any of Examples 1-21, and further comprising generating an adjusted response rate for the testing dataset that represents a percentage of responses in the testing dataset in which the one or more learning models declined to answer a question excluding questions where the discernment score is below a threshold discernment score.

Example 23 is one or more machine-readable storage media comprising a plurality of instructions stored thereon that, in response to being executed, cause a compute device to obtain a testing dataset comprising a plurality of questions and responses between one or more users and one or more large language models, wherein responses from the one or more large language models are based, at least in part, on information in a knowledge base; and determine a discernment score for the testing dataset, wherein the discernment score represents a measurement of whether there was enough information in the knowledge base for the one or more large language models to answer the questions in the testing dataset.

Example 24 includes the subject matter of any of Example 23, and wherein to determine the discernment score comprises to determine the discernment score using one or more large language models.

Example 25 includes the subject matter of Examples 23 and 24, and wherein to determine the discernment score comprises to prompt the one or more large language models with instructions on how to determine the discernment score.

Example 26 includes the subject matter of any of Examples 23-25, and wherein to determine the discernment score comprises to provide the one or more large language models with rules on how to determine the discernment score.

Example 27 includes the subject matter of any of Examples 23-26, and wherein to determine the discernment score comprises to provide one or more shots regarding discernment scoring to the one or more large language models.

Example 28 includes the subject matter of any of Examples 23-27, and wherein to determine the discernment score includes determining a relevance of each question in the testing dataset to information in the knowledge base.

Example 29 includes the subject matter of any of Examples 23-28, and wherein to determine the discernment score comprises generating, for at least a portion of the questions in the test dataset, a number between a first predetermined number and a second predetermined number.

Example 30 includes the subject matter of any of Examples 23-29, and wherein the first predetermined number represents a question in which information in the knowledge base answering none of the question.

Example 31 includes the subject matter of any of Examples 23-30, and wherein the second predetermined number represents a question in which information in the knowledge base completely answers the question.

Example 32 includes the subject matter of any of Examples 23-31, and wherein the discernment score is an average of the discernment score determined for each question in the test dataset.

Example 33 includes the subject matter of any of Examples 23-32, and wherein the instructions further cause the compute device to generate an adjusted response rate for the testing dataset that represents a percentage of responses in the testing dataset in which the one or more learning models declined to answer a question excluding questions where the discernment score is below a threshold discernment score.

Example 34 is a compute device comprising circuitry configured to receive a question from a user; obtain relevant information from a knowledge base based on the question from the user; generate an augmented prompt that combines the user's question with relevant content from the knowledge base; determine a discernment score for the augmented prompt, wherein the discernment score represents a measurement of whether there was enough information in the knowledge base to answer the questions in the testing dataset; provide the augmented prompt to one or more large language models responsive to the discernment score exceeding a threshold discernment score; and provide a message to the user indicating that the one or more large language models are unable to answer the user's question responsive to the discernment score falling below the threshold discernment score.

Example 35 includes the subject matter of Example 34, and wherein responsive to the discernment score falling below the threshold discernment score, the circuitry is further configured to adjust the augmented prompt based on the knowledge base.

Example 36 includes the subject matter of Examples 34 and 35, and wherein the circuitry is further configured to determine an adjusted discernment score of the adjusted augmented prompt, and responsive to the adjusted discernment score exceeding the threshold discernment score, providing the augmented prompt to one or more large language models.

Example 37 includes the subject matter of any of Examples 34-36, and wherein responsive to the discernment score falling below the threshold discernment score, the circuitry is further configured to prompt the user for missing information needed to increase the discernment score.

Example 38 includes the subject matter of any of Examples 34-37, and wherein responsive to the discernment score falling below the threshold discernment score, the circuitry is further configured to prompt the user for missing information needed to increase the discernment score.

Example 39 includes the subject matter of any of Examples 34-38, and wherein the threshold discernment score is user-adjustable.

Example 40 includes the subject matter of any of Examples 34-39, and wherein the circuitry is further configured to generate an answer in response to the augmented prompt.

Example 41 is a method comprising receiving a question from a user; obtaining relevant information from a knowledge base based on the question from the user; generating an augmented prompt that combines the user's question with relevant content from the knowledge base; determining a discernment score for the augmented prompt, wherein the discernment score represents a measurement of whether there was enough information in the knowledge base to answer the questions in the testing dataset; providing the augmented prompt to one or more large language models responsive to the discernment score exceeding a threshold discernment score; and providing a message to the user indicating that the one or more large language models are unable to answer the user's question responsive to the discernment score falling below the threshold discernment score.

Example 42 includes the subject matter of Example 41, and wherein responsive to the discernment score falling below the threshold discernment score, the circuitry is further configured to adjust the augmented prompt based on the knowledge base.

Example 43 includes the subject matter of Examples 41 and 42, and wherein the circuitry is further configured to determine an adjusted discernment score of the adjusted augmented prompt, and responsive to the adjusted discernment score exceeding the threshold discernment score, providing the augmented prompt to one or more large language models.

Example 44 includes the subject matter of any of Examples 41-43, and wherein responsive to the discernment score falling below the threshold discernment score, the circuitry is further configured to prompt the user for missing information needed to increase the discernment score.

Example 45 includes the subject matter of any of Examples 41-44, and wherein responsive to the discernment score falling below the threshold discernment score, the circuitry is further configured to prompt the user for missing information needed to increase the discernment score.

Example 46 includes the subject matter of any of Examples 41-45, and wherein the threshold discernment score is user-adjustable.

Example 47 includes the subject matter of any of Examples 41-46, and wherein the circuitry is further configured to generate an answer in response to the augmented prompt.

Example 48 is one or more machine-readable storage media comprising a plurality of instructions stored thereon that, in response to being executed, cause a compute device to receive a question from a user; obtain relevant information from a knowledge base based on the question from the user; generate an augmented prompt that combines the user's question with relevant content from the knowledge base; determine a discernment score for the augmented prompt, wherein the discernment score represents a measurement of whether there was enough information in the knowledge base to answer the questions in the testing dataset; provide the augmented prompt to one or more large language models responsive to the discernment score exceeding a threshold discernment score; and provide a message to the user indicating that the one or more large language models are unable to answer the user's question responsive to the discernment score falling below the threshold discernment score.

Example 49 includes the subject matter of Example 48, and wherein responsive to the discernment score falling below the threshold discernment score, the instructions further cause the compute device to adjust the augmented prompt based on the knowledge base.

Example 50 includes the subject matter of Examples 48 and 49, and wherein the instructions further cause the compute device to determine an adjusted discernment score of the adjusted augmented prompt, and responsive to the adjusted discernment score exceeding the threshold discernment score, providing the augmented prompt to one or more large language models.

Example 51 includes the subject matter of any of Examples 48-50, and wherein responsive to the discernment score falling below the threshold discernment score, the instructions further cause the compute device to prompt the user for missing information needed to increase the discernment score.

Example 52 includes the subject matter of any of Examples 48-51, and wherein responsive to the discernment score falling below the threshold discernment score, the circuitry is further configured to prompt the user for missing information needed to increase the discernment score.

Example 53 includes the subject matter of any of Examples 48-52, and wherein the threshold discernment score is user-adjustable.

Example 54 includes the subject matter of any of Examples 48-53, and wherein the instructions further cause the compute device to generate an answer in response to the augmented prompt.

1. A compute device comprising:
circuitry configured to:
obtain a testing dataset comprising a plurality of questions and responses between one or more users and one or more large language models, wherein responses from the one or more large language models are based, at least in part, on information in a knowledge base; and
determine a discernment score for the testing dataset, wherein the discernment score represents a measurement of whether there was enough information in the knowledge base for the one or more large language models to answer the questions in the testing dataset.

2. The compute device of claim 1, wherein to determine the discernment score comprises to determine the discernment score using one or more large language models, wherein to determine the discernment score comprises to prompt the one or more large language models with instructions on how to determine the discernment score.

3. The compute device of claim 2, wherein to determine the discernment score comprises to provide the one or more large language models with rules on how to determine the discernment score.

4. The compute device of claim 2, wherein to determine the discernment score comprises to provide one or more shots regarding discernment scoring to the one or more large language models.

5. The compute device of claim 2, wherein to determine the discernment score includes determining a relevance of each question in the testing dataset to information in the knowledge base.

6. The compute device of claim 5, wherein to determine the discernment score comprises generating, for at least a portion of the questions in the test dataset, a number between a first predetermined number and a second predetermined number.

7. The compute device of claim 6, wherein the first predetermined number represents a question in which information in the knowledge base answering none of the question, and wherein the second predetermined number represents a question in which information in the knowledge base completely answers the question.

8. The compute device of claim 1, wherein the discernment score is an average of the discernment score determined for each question in the test dataset.

9. The compute device of claim 1, wherein the circuitry is further configured to generate an adjusted response rate for the testing dataset that represents a percentage of responses in the testing dataset in which the one or more learning models declined to answer a question excluding questions where the discernment score is below a threshold discernment score.

10. One or more machine-readable storage media comprising a plurality of instructions stored thereon that, in response to being executed, cause a compute device to:
obtain a testing dataset comprising a plurality of questions and responses between one or more users and one or more large language models, wherein responses from the one or more large language models are based, at least in part, on information in a knowledge base; and
determine a discernment score for the testing dataset, wherein the discernment score represents a measurement of whether there was enough information in the knowledge base for the one or more large language models to answer the questions in the testing dataset.

11. The one more machine-readable storage media of claim 10, wherein to determine the discernment score comprises to determine the discernment score using one or more large language models.

12. The one more machine-readable storage media of claim 11, wherein to determine the discernment score includes determining a relevance of each question in the testing dataset to information in the knowledge base.

13. The one more machine-readable storage media of claim 10, wherein the instructions further cause the compute device to generate an adjusted response rate for the testing dataset that represents a percentage of responses in the testing dataset in which the one or more learning models declined to answer a question excluding questions where the discernment score is below a threshold discernment score.

14. A compute device comprising:
circuitry configured to:
receive a question from a user;
obtain relevant information from a knowledge base based on the question from the user;
generate an augmented prompt that combines the user's question with relevant content from the knowledge base;
determine a discernment score for the user's question, wherein the discernment score represents a measurement of whether there was enough information in the knowledge base to answer the user's question;
provide the augmented prompt to one or more large language models responsive to the discernment score exceeding a threshold discernment score; and
provide a message to the user indicating that the one or more large language models are unable to answer the user's question responsive to the discernment score falling below the threshold discernment score.

15. The compute device of claim 14, wherein responsive to the discernment score falling below the threshold discernment score, the circuitry is further configured to adjust the augmented prompt based on the knowledge base.

16. The compute device of claim 15, wherein the circuitry is further configured to determine an adjusted discernment score of the adjusted augmented prompt, and responsive to the adjusted discernment score exceeding the threshold discernment score, providing the augmented prompt to one or more large language models.

17. The compute device of claim 14, wherein responsive to the discernment score falling below the threshold discernment score, the circuitry is further configured to prompt the user for missing information needed to increase the discernment score.

18. The compute device of claim 14, wherein responsive to the discernment score falling below the threshold discernment score, the circuitry is further configured to prompt the user for missing information, or for confirmation that the information in the knowledge base is sufficient so that the augmented prompt can be adjusted to indicate to the one or more large language models that an answer can be generated with increased confidence.

19. The compute device of claim 14, wherein the threshold discernment score is user-adjustable.

20. The compute device of claim 14, wherein the circuitry is further configured to generate an answer in response to the augmented prompt.
